(19) United States
(12) Patent Application Publication
(10) Pub. No.: US 2025/0253641 A1
(43) Pub. Date: Aug. 7, 2025

(54) Offshore Structure, In Particular A Floatable Offshore Structure

(71) Applicants: Jörn Runge, Marklohe (DE); Aron von Schéele, Malmö (SE)

(72) Inventors: Jörn Runge, Marklohe (DE); Aron von Schéele, Malmö (SE)

(73) Assignee: RWE Offshore Wind GmbH, Essen (DE)

(21) Appl. No.: 19/090,588

(22) Filed: Mar. 26, 2025

Related U.S. Application Data
(63) Continuation of application No. PCT/EP2022/077263, filed on Sep. 30, 2022.

(51) Int. Cl. H02H 5/10; H02G 9/00

(52) U.S. Cl. CPC H02H 5/10; H02G 9/00

(57) ABSTRACT

An offshore structure that is a floatable offshore structure that includes at least one submarine cable connector configured to connect a submarine power cable to an electrical device of the offshore structure. The offshore structure also includes at least one messenger line. A first end of the messenger line is fixed to the submarine power cable and a further end of the messenger line is fixed to the offshore structure.

### CROSS-REFERENCE TO RELATED PATENT APPLICATIONS

This patent application is a continuation of International Application No. PCT/EP2022/077263, filed on Sep. 30, 2022, the entire teachings and disclosures are incorporated herein by reference thereto.

### FIELD OF THE INVENTION

The application relates to an offshore structure, in particular a floatable offshore structure, comprising at least one submarine cable connector configured to connect a submarine power cable to an electrical device of the offshore structure. Furthermore, the application relates to a messenger line arrangement, a submarine power cable arrangement and a power generation system.

### BACKGROUND OF THE INVENTION

In the present time, power generation systems are increasingly used for the provision of electrical energy, in which the generation of electrical energy is based on so-called renewable energy sources. Electric power generation systems have at least one power generation device, preferably a plurality of power generation devices.

For example, wind energy systems and wind farms, respectively, comprising at least one wind turbine as an energy generation device are used as electrical energy generation systems. In particular, a wind turbine is configured to convert the kinetic wind energy into electrical energy. In addition to wind farms, photovoltaic systems and photovoltaic farms, respectively, are also increasingly constructed as electrical energy generation systems, in which a plurality of photovoltaic modules are generally provided for electrical energy generation.

Such power generation systems are not only located at onshore sites, but increasingly also at offshore sites. There are many reasons for choosing an offshore site: for example, the available space onshore may be limited. In addition, it has been shown that the energy yield can be increased at wind farms, for example. Offshore locations are usually characterized by relatively continuous wind conditions and high average wind speeds, so that offshore wind farms are increasingly being built. Offshore photovoltaic farms, for example, may be installed due to space constraints.

Typically, an offshore power generation system has a plurality of (stationary) offshore structures, such as a plurality of offshore wind turbines and at least one offshore substation (also called converter station) through which an offshore wind farm can be electrically connected, for example, to an onshore substation or another offshore substation.

An onshore substation, in turn, may be connected to a public power grid. In order to transmit electrical power between two offshore structures or an offshore structure and an onshore structure, power cables in the form of submarine power cables are laid between said structures.

While it has been common practice so far for offshore wind turbines and offshore substations, but also for other offshore structures, such as photovoltaic platforms, platforms for gas or oil exploration, platforms for hydrogen production etc., to anchor them by a foundation structure (e.g. monopile foundation, tripod foundations, tripile foundation, jacket foundation and the like) on or in the underwater bottom, in particular a seabed, there are increasing considerations to install floatable respectively buoyant offshore structures, for example floatable power generation devices, such as floatable offshore wind turbines or floatable photovoltaic platforms.

One reason for using floatable offshore structures is the possibility of installing such offshore structures in areas with a large water depth, for example, of more than 150 meters.

A buoyant offshore structure and floatable offshore structure, respectively, may comprise at least one floatable foundation having at least one floating body. The offshore structure, in particular, an offshore device supported by the foundation, may have at least one submarine power cable connector. In variants, the submarine power cable connection may also be arranged at the foundation. A submarine power cable connector is configured to connect a submarine power cable, in particular with an electrical device of the offshore structure.

For example, a transformer device with at least one transformer, a wind power device, a photovoltaic device, a hydrogen production device, etc. may be installed as an offshore device on the foundation of the offshore structure.

In particular, in the case of floatable offshore structures, but also in the case of non-floatable (and installed on the seabed via a conventional foundation) offshore structures, a (mechanical) separation of the submarine power cable from the submarine cable connection may occur. A mechanical separation of the submarine power cable may have different causes. For example, mechanical separation may be intentional for maintenance reasons, repair reasons. However, a mechanical separation of a submarine power cable from an offshore structure may comprise an (unintentional) breakage of the submarine power cable.

The risk of such an (unintentional) breakage is particular high for floatable offshore structures, as will be described hereinafter: For a (permanent) stationary operation of a floatable offshore structure at a particular installation site, the floatable offshore structure is attached to the subsea bottom (typically a seabed) by at least one mooring arrangement. The at least one mooring arrangement is configured to secure the floatable offshore structure to a seabed in a mooring condition or installation state of the offshore structure.

To this end, the mooring arrangement may comprise at least one anchor connection extending between an anchor that is at least partially buried in the seabed and the floatable offshore structure. The offshore structure may comprise at least one anchor connector. The anchor connector may be configured to connect at least one anchor connection for anchoring the floatable offshore structure to the seabed. In preferred variants, two or more anchor connections may be connected and attached, respectively, to respective anchor connectors of the offshore structure.

A problem with the floatable offshore structures described is that an anchor connection can break and be separated, respectively, during the operation of a floatable offshore structure. For example, an anchor connection can break due to the high mechanical loads that act on an anchor connection during operation, an accident with a watercraft, or the like.

As a result of a broken anchor connection, the connected submarine power cable may also break and rupture, respectively. If a submarine power cable breaks it sinks to the seabed. This is particularly problematic in the case of large water depths. Locating the submarine cable at depth is complex and time-consuming. After locating the submarine cable, a complicated salvage operation is then necessary. It shall be noted that e.g. due to high mechanical loads, also a submarine power cable can be separated from a non-floatable offshore structure.

### SUMMARY OF THE INVENTION

Therefore, it is the object of the present application to provide a possibility to reduce the effort for salvaging a submarine power cable mechanically separated from an offshore structure.

According to a first aspect of the application, the object is solved by an offshore structure according to claim 1, in particular a floatable offshore structure. The offshore structure comprises at least one submarine cable connector configured to connect a submarine power cable to at least one electrical device of the offshore structure. The offshore structure further comprises at least one messenger line. A first end of the messenger line is fixed to the submarine power cable and a further end of the messenger line is fixed to the offshore structure.

In contrast to the prior art, according to the application a possibility to reduce the effort for salvaging a submarine power cable mechanically separated, in particular broken, from an offshore structure is provided by providing a messenger line between the offshore structure and the submarine power cable. The messenger line is in particular configured to hold a broken submarine power cable. Since the messenger line is connected to a submarine power cable after a breakage, there is no need for complex locating of the broken submarine power cable. Also the salvage operation of the separated submarine power cable still linked to the offshore structure is facilitated.

The offshore structure is in particular a stationary offshore structure in operation, i.e. after an installation of the offshore structure. In particular, a vehicle, like a ship, vessel etc. is not an offshore structure according to the present application. Preferably, the offshore structure is a floatable (stationary) offshore structure that floats at a specific installation site.

The offshore structure according to the application comprises at least one submarine (power) cable connector. For example, two submarine power connectors may be provided. A submarine power connector is configured for connecting a submarine power cable, in particular during operation of the offshore structure. For example, two submarine power cables may be connected to an offshore structure by respective submarine power connectors.

In particular, a submarine power cable is configured to transmit electrical energy and power, respectively. The submarine power cable is preferably a medium-voltage submarine power cable (in particular between 3 kV to 30 kV) or a high-voltage submarine power cable (60 kV to 110 kV). The power capacity of a submarine power cable according to the application is preferably between 3 MW and 2.5 GW. In addition, a submarine power cable may also be equipped for data transmission.

In particular, a submarine power cable according to the application may run from the submarine cable connector to the subsea bottom and then through the subsea bottom in a specific depth range. If a further structure connected to the submarine power cable is also an offshore structure, the submarine power cable may then run from the subsea floor to a further submarine cable connector of the further (floatable) offshore structure. If the further structure connected to the submarine power cable is an onshore structure, the submarine power cable may run substantially through the bottom to the further submarine cable connector of the onshore structure.

The at least one submarine cable connector is configured to connect a submarine power cable to one or more electrical device(s) of the offshore structure. The offshore structure may preferably comprise a foundation configured to support at least one offshore device comprising the at least one electrical device.

The floatable offshore structure may comprise the offshore device disposed on the foundation. This offshore device may comprise the at least one submarine cable connector. Preferably, the offshore device may comprise at least one electrical device in form of an electrical power generation device or an electrical consumer. Exemplary and non-exhaustive offshore devices comprise substation devices comprising at least one electrical transformer, wind power devices (e.g. comprising a tower, nacelle, rotor, generator, etc.), photovoltaic devices (preferably comprising a plurality of photovoltaic modules), and hydrogen production devices, in particular a water electrolysis device.

According to a preferred embodiment of the (floatable) offshore structure according to the application, the foundation may be a floatable foundation comprising at least one floating body. A floating body and buoyant body, respectively, is independently buoyant, in particular, due to its buoyancy by displacement according to Archimedes' principle. Floating bodies may, for example, be hollow and filled with a gas, e.g. air, or with a light solid. In particular, the buoyant foundation may substantially form the floating body.

Preferably, the floatable foundation may be a so-called barge foundation, semi-submersible foundation, spar foundation and/or tension leg platform (TLP) foundation. It shall be understood that other types of floatable foundations may be provided in other variants of the application.

According to the present application, it has been recognized that the effort for salvaging a broken submarine power cable can be reduced if at least one messenger line and messenger wire, respectively, is connected between the submarine power cable connected to the submarine cable connector of the offshore structure and the offshore structure. The connection of the messenger line to the offshore structure can be a direct connection or indirect connection (e.g. by means of a buoy associated with the offshore structure).

According to the application, the first end of the messenger line is (firmly) fixed to the submarine power cable. The further end of the messenger line is (firmly) fixed to the offshore structure. The messenger line is in particular connected to the submarine power cable and the offshore structure such that upon a breakage of the submarine power cable there is still a link between the submarine power cable and the offshore structure via the messenger line.

According to a further embodiment of the offshore structure according to the application the first end of the messenger line may be fixed to the submarine power cable in an end area of a first end of the submarine power cable which is connected to the submarine cable connector. The length of the end area (starting from the submarine cable connector of the offshore structure) is in particular between 0 m and 40 m, particularly preferred between 0 m and 20 m. It has been recognized that if a submarine power cable breaks, it usually breaks at a cable point within a distance to the submarine cable connector of 0 to 20 m, in particular of 0 to 1 m.

Alternatively or additionally, the first end of the messenger line may be fixed to the submarine power cable at the cable connector (in particular, a plug of the submarine power cable) of the submarine power cable (which is connected to the submarine cable connector of the offshore structure). It has been in particular recognized that if a submarine power cable breaks, it usually breaks at a cable point between the respective cable connectors. Further, a messenger line can be easily fixed to a cable connector of the submarine power cable.

According to a preferred embodiment of the offshore structure according to the application, the submarine power cable may comprise a weak link, in particular in the end area of the first end of the submarine power cable. The weak link is in particular a predetermined separation point. The weak link may be an area of the submarine power cable that is (mechanically and/or structurally) configured in such a way that the tensile strength at said weak link is lower than in the remaining cable area of the submarine power cable. By providing a specifically designed weak link it can be in particular ensured that if the submarine power cable breaks, it breaks (at least with a high likelihood) (only) at the weak link.

Preferably, the first end of the messenger line may be fixed to the submarine power cable downstream the weak link starting from the submarine cable connector of the offshore structure. It can be ensured that if the submarine power cable breaks (at the weak link), there is still a link between the offshore structure and the submarine power cable via the connected messenger line.

According to a further embodiment, the offshore structure may comprise at least one switching device configured to mechanically separate the submarine power cable upon receipt of a separation instruction. The switching device can be connected, for instance, at the weak link. In order to prevent an uncontrolled cable breakage, a separation instruction can be transmitted to the switching device in particular upon detection of an (imminent) cable breakage (for example, due to the detection of an anchor connection break indication). The switching device can then immediately perform a controlled separation at a cable location specified for this purpose (e.g. the weak link). Preferably, the first end of the messenger line may be fixed to the submarine power cable downstream the cable location specified for this purpose (e.g. the weak link) starting from the submarine cable connector of the offshore structure. In one embodiment, the weak link can be at the hang-off of the offshore structure.

According to a further embodiment of the offshore structure according to the application, the first end of the messenger line may be fixed to the submarine power cable via at least one fixing module. The at least one fixing module may be selected from the group, comprising
at least one eyelet attached to the cable connector,
at least one eyelet attached to the submarine power cable, in particular, a cable sheath of the submarine power cable,
at least one additional (cable) sheath of submarine power cable in which the first end of the messenger line is integrated, and
at least one Chinese finger in which the first end of the messenger line is integrated.

A secure fixation and at the same time easy-to-establish fixation can be provided.

A similar fixing module (e.g. an eyelet, a Chinese finger, a welding connection etc.) can be used for fixing the further end of the messenger line to the offshore structure.

In addition, according to a further embodiment of the offshore structure according to the application, the further end of the messenger line may be fixed to the offshore structure at at least one structure component (at least associated with the offshore structure). The at least one structure component may be selected from the group, comprising:
a hang-off of the offshore structure,
an airtight deck of the offshore structure,
a hollow structure (preferably a J-tube) configured to guide the submarine power cable from the submarine cable connector along the offshore structure,
a (floating) foundation of the offshore structure,
at least one buoy at least associated with the offshore structure.

A hang-off (system) of the offshore structure may be configured to secure a submarine power cable to the top of a foundation/cable deck of the offshore structure. An airtight deck of the offshore structure may be integrated in the offshore device and may be in particular disposed above a service platform of the offshore structure.

In order to guide a submarine power cable connected to the submarine cable connector in a defined manner towards the sea floor, the offshore structure may comprise a hollow (guiding) structure. The submarine power cable may extend through the hollow structure from the submarine cable connector to an outlet of the hollow structure. The further end of the messenger line may be fixed to an inner side of the hollow structure or to an outer side of the hollow structure.

Alternatively or additionally, the further end of the messenger line may be fixed to the at least one foundation (in particular, a foundation wall) of the offshore structure.

At least one buoy may be associated with the offshore structure. A buoy may be associated with the offshore structure if the buoy is permanently within a specific vicinity (e.g. with a radius of X meters) to the (installed) offshore structure at the installation site. The advantage of a buoy (not permanently connected to a floatable offshore structure) is that also in the case that a floatable offshore structure drifts (significantly) away from the original installation site and position, respectively, a breakage of the messenger line will not occur due to the connection of the submarine power cable with the buoy via the messenger line. Also in the case of a drifted floatable offshore structure the salvage process can be facilitated.

In order to maintain the connection by the messenger line between the offshore structure and the submarine power cable upon a breakage of the submarine power cable, according to an embodiment of the offshore structure according to the present application, the messenger line may be configured in such a way that it allows a maximum force of at least 1000 kN, preferably at least 1500 kN. For example, based on a 1500 m long 275 kV submarine cable with a cross-section of 2000 mm², the messenger line may be configured to allow a maximum force of at least 1500 kN.

In particular, in order to allow such a maximum force, according to an embodiment of the offshore of the present application, the messenger line may be made of a material selected from the group, comprising:
metal, in particular steel,
plastics,
fibre-reinforced plastics, in particular carbon-fibre-reinforced polymers, glass-fibre-reinforced polymers and/or aramid-fibre-reinforced polymers.

Particularly preferred are steel ropes and/or fibre-reinforced plastics ropes. Preferably, two or more steel ropes and/or fibre-reinforced plastics ropes may be twisted together to form a messenger line.

It has been recognized that although the submarine power cable may comprise a specific weak link, from time to time a submarine power cable may break at another cable point. A further problem which sometimes occurs is that the messenger line also breaks. In order to be able to locate a broken submarine power cable also in these cases, according to an embodiment of offshore structure according to the application, the submarine power cable may comprise at least one tracking transmitter. In particular, the offshore structure may comprise the submarine power cable.

The at least one tracking transmitter may be sonar-based tracking transmitter and/or electromagnetic based tracking transmitter. Preferably, the tracking transmitter may be an emergency locator beacon, such as an emergency position-indicating radio beacon (EPIRB). The tracking transmitter can be automatically activated upon a breakage. The tracking transmitter may be battery powered. Upon activation, the tracking transmitter may be configured to broadcast its position (for instance, with an accuracy of 100 m).

Alternatively or additionally, the offshore structure may comprise two messenger lines each connected to the same submarine power cable. The respective first ends of the respective messenger lines may be fixed to the submarine power cable (preferably at different distances to the submarine cable connector) and the respective further ends of the respective messenger lines may be fixed to the offshore structure. In other words, for each submarine power cable, two or more messenger lines can be provided.

Alternatively or additionally, the submarine power cable may be additionally equipped with at least one inflatable floating body. The at least one inflatable floating body may be arranged at least one cable end area of the submarine power cable. The inflatable floating body may comprise at least one inflatable bag configured to inflate upon a receipt of a triggering instruction. The inflatable floating body may comprise an inflatable bag which is in particular configured to inflate when the submarine power cable is broken. The salvage operation of the separated submarine power cable can be facilitated due to the inflated inflatable floating body carrying the broken submarine power cable at the sea surface in the inflated state.

Preferably, the inflatable floating body may be fixed to the submarine power cable downstream the weak link (starting or viewed from the cable connector of the submarine power cable or in the connected state from the submarine cable connector of the offshore structure). The inflatable floating body may be fixed to the submarine power cable via at least one fixing module. The at least one fixing module may be selected from the group, comprising:
at least one eyelet attached to the cable connector,
at least one eyelet attached to the submarine power cable, in particular, a cable sheath of the submarine power cable,
at least one additional sheath in which inflatable floating body is at least partly integrated,
at least one Chinese finger in which inflatable floating body is at least partly integrated,
a weld connection, and
an adhesive connection.

According to a preferred embodiment of the offshore structure according to the application, the inflatable floating body may comprise at least one gas generator and the at least one inflatable bag. The at least one inflatable bag and hull, respectively, is in particular an airbag. The gas generator may be configured to fill the inflatable bag with a gas. A gas generator may provide the gas to fill the inflatable bag, in particular the airbag. In particular, (directly) upon an activation of the inflatable floating body, the gas generator may inject the gas into the inflatable bag. After the inflatable bag is essentially fully inflated (i.e. the inflatable bag is in the inflated state), the inflatable floating body may be configured to seal the inflated bag such that the gas remains in the inflated bag.

Preferably, the at least one gas generator is selected from the group, comprising:
a compressed air reservoir,
a pyrotechnic gas generator,
a cold gas generator, and
a hybrid gas generator.

A compressed air reservoir may comprise a valve which can be opened to fill the inflatable floating body with the air stored in the compressed air reservoir. Such an embodiment could be advantageous, as such a compressed air reservoir with a drivable valve can simplify the design and practicality of the inflatable floating body. In particular, usually a particular fast inflation process is not necessary.

A pyrotechnic gas generator may comprise an ignition unit and a solid propellant. The ignition unit may be activated by a current pulse. The current pulse may ignite the solid propellant, which might be in tablet form. The resulting hot gas (e.g. ˜ 1350° C.) may flow from the gas generator into the inflatable bag. Due to the expansion, the temperature of the gas flowing into the inflatable bag may reduce (e.g. to only around 150° C.).

A cold gas generator may comprise a gas reservoir and an activator. For instance, a helium-argon mixture can be stored under high pressure. When the inflatable floating body is triggered, an explosive device may destroy a membrane and the cold gas may stream into the inflatable bag. A hybrid gas generator is in particular a combination of a pyrotechnic gas generator and a cold gas generator. It shall be understood that other gas generators can be used.

According to a further embodiment of the offshore structure according to the application, the inflatable floating body may comprise at least one controller configured to receive the triggering instruction. The controller may be configured to drive at least one gas generator (in particular, at least one of the previously described gas generators) such that the gas generator is caused to fill the inflatable bag with the gas.

Furthermore, according to an embodiment of the offshore structure according to the application, the inflatable floating body may comprise at least one trigger sensor configured to detect at least one trigger event. A trigger (breakage) event according to the application is in particular an event that indicates that the submarine power cable is (actually) broken. The trigger sensor may be configured to generate the triggering instruction upon a detection of the trigger event. In other words, the triggering instruction may represent (or result from) a detected broken submarine power cable. Generating the triggering instruction may comprise providing, in particular transmitting the triggering instruction to the controller (in order to activate the inflatable floating body).

Alternatively and preferably additionally, the inflatable floating body may comprise at least one receiving module configured to receive a trigger event information. A trigger event information is an information which is generated upon a trigger event (detected e.g. by a trigger sensor (in particular, in form of a detection arrangement described in more details hereinafter) not comprised by the inflatable floating body but e.g. comprised by the offshore structure) which indicates that the submarine power cable is broken. The receiving module may be configured to generate the triggering instruction upon a receipt of the trigger event information. Generating the triggering instruction may comprise providing, in particular transmitting the triggering instruction to the controller (in order to activate the inflatable floating body).

According to a further embodiment of the offshore structure according the application, the at least one trigger sensor may be selected from the group, comprising:
an acceleration sensor,
a water contact sensor,
a ripcord sensor,
a hollow structure sensor configured to detect that the inflatable floating body is no longer within a hollow structure configured to guide the submarine power cable from a submarine cable connector of an offshore structure along the offshore structure.

Generally, a trigger sensor may be configured to (continuously) measure or monitor at least one parameter which is indicative for a submarine power cable breakage. The trigger sensor may be configured to evaluate whether the at least one (continuously) measured or monitored parameter (value) satisfies a broken cable criterion (e.g. a predetermined parameter value range and/or at least one predetermined limit parameter value) or not. If the at least one (continuously) measured or monitored parameter (value) satisfies a broken cable criterion, the trigger sensor detects said trigger event. If the at least one (continuously) measured or monitored parameter (value) does not satisfy a broken cable criterion, the trigger sensor does not detect said trigger event.

For instance, an acceleration sensor may (continuously) measure at least one acceleration parameter of the inflatable floating body. When the at least one acceleration parameter excesses a predetermined acceleration limit value, the acceleration sensor may detect said trigger event. In particular, it can be assumed that an acceleration sensor integrated in the inflatable floating body experiences an acceleration higher than the acceleration limit value only if the submarine power cable is broken and e.g. falls into the sea.

Furthermore, a water contact sensor measure may (continuously) measure or monitor at least one moisture parameter. The inflatable floating body can be arranged such that in the unbroken state of the submarine power cable, the inflatable floating body and thus the water contact sensor is always not in contact with water. When the at least one moisture parameter excesses a predetermined moisture limit value, the water contact sensor may detect said trigger event. In particular, it can be assumed that water contact sensor integrated in the inflatable floating body may experiences a moisture value higher than the moisture limit value only if the submarine power cable is broken and fallen into the sea.

A ripcord sensor may be connected with a ripcord, wherein a first end of the ripcord is connected to ripcord sensor and the other end is connected to e.g. a structure component of the offshore structure. In particular, the ripcord is connected to the ripcord sensor such that in case of a broken power cable the ripcord is also disconnected. This can be monitored by the ripcord sensor. The broken cable criterion might be a non-intact ripcord (or the like). If this is detected, the ripcord sensor may detect said trigger event.

A hollow structure sensor (for instance, a light sensor, a contact sensor, etc.) may be configured to detect that the inflatable floating body is no longer within a hollow structure (e.g. J-tube) configured to guide the submarine power cable from a submarine cable connector of an offshore structure along the offshore structure. The inflatable floating body can be arranged such that in the unbroken state of the submarine power cable, the inflatable floating body and thus the water contact sensor is within the hollow structure. In particular, the hollow structure sensor may evaluate at least one monitored parameter based on at least one broken cable criterion whether the hollow structure sensor is outside the hollow structure or not.

In particular, it can be assumed that in normal operation the inflatable floating body and thus the hollow structure sensor is within the hollow structure. If the hollow structure sensor detects that the hollow structure sensor and thus the inflatable floating body is no longer within a hollow structure, it can be assumed that the submarine power cable has been broken and has fallen out of the hollow structure. A further advantage of this sensor is that it can be ensured that the inflatable floating body is not activated until it is outside the hollow structure. Damage to an already inflated floating body due to the hollow structure can be prevented.

To ensure that the inflatable floating body is only activated after it has left the hollow structure (and when another sensor (e.g. acceleration sensor, ripcord sensor, water contact sensor, and/or a subsequently described detection arrangement)), a time-delayed triggering (which depends, for example, on the length of the hollow body) can also be used.

Furthermore, according to a further embodiment of the offshore structure according the application the inflatable bag may have in an inflated state (and activated state, respectively) a volume between 0.5 m³ and 500 m³, preferably between 1.5 m³ and 150 m³. Such a volume may ensure a sufficient buoyancy such that the cable end may float at the water surface. Alternatively and preferably additionally, the inflatable bag may have in a non-inflated state (and inactivated state, respectively) a volume between 0.001 m³ and 10 m³, preferably between 0.01 m³ and 4 m³. An inflatable floating body having an inflatable bag with such a small volume can be attached to a submarine power cable in a simple manner.

According to a preferred embodiment of the offshore structure according to the application, a length, in particular a design of the length, of the at least one messenger line of the floatable offshore structure is based on the water depth at the installation site of the floatable offshore structure, the number anchor connections of the floatable offshore structure and/or the shape of the course of an anchor connection from the floatable offshore structure to an anchor fixed in the subsea floor. It has been recognized that in case of a floatable offshore structure, a breakage of a submarine power cable is likely if one of the plurality of anchor connections of the floatable offshore structure is broken. If this is the case, the floatable offshore structure usually drifts from its original installation point to a maximum drift position defined by the remaining anchor connections. In order to avoid also a breakage of the link between the offshore structure (e.g. the foundation, the airtight deck, the hang-off (not an associated buoy) etc.) and the submarine power cable due to a drift of the offshore structure, the length of the messenger line is determined based on at least one of the previous parameter. For instance, the offshore structure may comprise a messenger line compartment for receiving the messenger line in an unused state of the messenger line, i.e. if no submarine power cable is broken.

Preferably, the length of the at least one messenger line of a floatable offshore structure can be at least greater than a maximum distance of movement and drift, respectively, of the floatable offshore structure that can maximally occur when one anchor connection of a plurality of anchor connections of the floatable offshore structure is broken.

According to a further embodiment of the offshore structure according to the application, the offshore structure may be a floatable offshore structure. The floatable offshore structure may comprise at least one anchor connector configured to connect at least one anchor connection for anchoring the floatable offshore structure to a subsea floor. The floatable offshore structure may comprise at least one detection arrangement configured to detect an anchor connection break indication. The floatable offshore structure may comprise at least one switching device configured to at least electrically disconnect the electrical connection to the submarine power cable connected to the submarine cable connector upon or after a detection of the anchor connection break indication.

By providing a detection arrangement for detecting an anchor connection break indication, in particular a rupture of an anchor connection or a disconnected anchor connection, and a switching device which interrupts the current flow through the connected submarine power cable upon such a detection, the safety during operation of the floatable offshore structure can be increased. A breakage of a live submarine power cable can be (safely) prevented. An unintentional short circuit can be avoided.

Preferably, if an optional switching device configured to mechanically separate the submarine power cable is provided, the detection arrangement may be configured to send the described separation instruction to the switching device in order to cause a (defined) separation of the submarine power cable from the offshore structure.

The floatable offshore structure comprises at least one anchor connector. In particular, the foundation may comprise at least one anchor connector. An anchor connector is configured to (mechanically) connect at least one anchor connection. In operation, the offshore structure is attached and anchored, respectively, to the subsea bottom via the at least one anchor connection.

An anchor connection according to the application is preferably an anchor rope and/or an anchor chain. An anchor rope may be formed of metal, in particular steel, and/or plastic, in particular at least one fiber composite material. Preferably, two or more anchor ropes may be twisted together to form an anchor connection. A sheath may be provided to protect the at least one anchor rope.

One end of the anchor connection may be connected (in the installation condition of the floatable offshore structure) to the anchor connector and the other end of the anchor connection may be connected to an anchor (e.g., weight anchor, torpedo anchor, etc.). The anchor may be at least partially buried in the subsea floor. Preferably, a floatable offshore structure may have three (or more) anchor connections, which may be attached, for example, to a corresponding number of anchor connectors of the offshore structure.

The detection arrangement can be used for direct and/or indirect monitoring of the at least one anchor connection, in particular of all anchor connections of the floatable offshore structure. In particular, the detection arrangement is configured to detect a broken anchor connection and a severed anchor connection, respectively.

A detection of an anchor connection break indication means in particular a detection of a particular event or parameter that indicates an (actual or potential) broken anchor connection or an anchor connection that has a high probability (e.g., >95%) of breaking (for example, due to a current load on the anchor connection exceeding a predetermined maximum allowable load). In particular, a potentially broken anchor connection is present if the detection arrangement detects a parameter or event that indicates a broken anchor connection, but may also have other causes, such as a defect in the detection arrangement (e.g., a measurement error or the like).

Upon or after detection of at least one anchor connection break indication, at least one electrical disconnection of the connection to the submarine power cable connected to the offshore structure and the electrical system, respectively, of the offshore structure is performed by the switching device. In particular, disconnecting the flow of electricity or interrupting the flow of energy through the at least one submarine power cable connected to the offshore structure occurs. In other words, the at least one submarine power cable is de-energized preferably by the switching device.

In particular, the switching device can comprise at least one load-break switch. The at least one load-break switch, in particular as a switching module. The load-break switch can be configured to switch electrical loads. A load-break switch may comprise at least one arc extinguishing module.

At or (directly) after a detection of the anchor connection break indication, the switching operation and/or the cable separation operation by the switching device can be caused. The time duration may be at least less than 10 seconds, in particular less than 5 seconds, particularly preferably less than 1 second. In other words, the switching device may preferably be configured for electrical disconnection immediately (i.e., in particular within a time duration of less than 1 second) upon or after detection of the anchor connection break indication.

According to a preferred embodiment of the offshore structure according to the application, the detection arrangement may comprise at least one position sensor. The at least one position sensor may be configured to detect the (instantaneous) position of the floatable offshore structure.

The detection arrangement may comprise at least one position evaluation module. The position evaluation module may be configured to detect the anchor connection break indication, based on the detected position and a predetermined allowable position range.

In particular, the at least one position sensor may be a satellite-based position sensor. For example, a GPS sensor, Galileo sensor, etc. may be provided as a position sensor.

In particular, the at least one position sensor is configured to substantially continuously detect the instantaneous geographic position of the offshore structure.

The detected position and the detected position data, respectively, in particular in the form of geographical coordinates (e.g. GPS data), can be provided (continuously) to the position evaluation module. In particular, the position evaluation module is configured to evaluate the detected position for detecting an anchor connection break indication.

Preferably, an allowable (geographic) position range of the floatable offshore structure is predetermined. In particular, the allowable position range may be determined before and/or during installing said offshore structure. In particular, the allowable position range specifies the maximum possible radius of movement of a floatable offshore structure anchored to the subsea bottom by at least one anchor connection and may depend, for example, on parameters such as the length (e.g., over 1000 m) of the at least one anchor connection, the number of anchor connections and/or a length buffer provided for the at least one submarine power cable.

The allowable position range may be equal to or preferably (slightly (e.g., 5%)) greater than the maximum radius of movement. The allowable position range ensures in particular that small position deviations due to measurement inaccuracy, but also caused by the weather conditions at the installation site, do not lead to a triggering of the switching device. Only larger deviations, which could endanger the submarine power cable, lead to the triggering of the switching device. The allowable position range can be defined in particular by limit position data (e.g. geographical coordinates, such as GPS coordinates). As long as the detected position data of the offshore structure is within the allowable position range, it can be assumed that the at least one anchor connection is intact or has not broken. In this case, the current flow is not disconnected and the submarine power cable is not mechanically separated by the switching device.

If, on the other hand, the detected position data of the offshore structure is outside the allowable position range, an event or parameter may be detected that indicates that the at least one anchor connection is (potentially or actually) broken.

In variants of the application, it can be provided that the switching device is only triggered in the described manner if the detected position of the offshore structure is outside the allowable position range for a specific (predetermined) period of time (e.g. between 0.5 s and 10 s). In the event that the detected position of the offshore structure is again within the allowable range before the specified time period has elapsed, the switching device may not be triggered.

According to a further embodiment of a (floatable) offshore structure according to the application, the detection arrangement may comprise at least one anchor connection structure sensor configured to detect at least one anchor connection structure parameter of the anchor connection. The detection arrangement may comprise at least one anchor connection structure evaluation module configured to detect the anchor connection break indication based on the at least one detected anchor connection structure parameter and at least one predetermined allowable anchor connection structure parameter range.

The at least one anchor connection structure sensor may be in particular selected from the group, comprising:
at least one electrical sensor configured to detect at least one electrical parameter of an electrical conductor guided at least partially along the anchor connection,
at least one optical sensor configured to detect at least one optical parameter of an optical conductor guided at least partially along the anchor connection,
at least one mechanical sensor configured to detect at least one mechanical parameter of a measuring rope guided at least partially along the anchor connection.

An electrical sensor may be part of an electrical sensor arrangement. The electrical sensor arrangement may further comprise an electrical (measurement) conductor having, for example, a forward line and a return line. In one embodiment, the offshore structure may comprise the at least one electrical sensor arrangement.

A forward line of an electrical conductor may preferably extend from the end of the anchor connection connected to the anchor connector to the other end of the anchor connection attached to the anchor. The return line may immediately follow the forward line and may extend from the other end of the anchor connection to the end of the anchor connection connected to the anchor connector. The electrical sensor may be connected to the forward line and the return line.

The electrical conductor may be arranged at the anchor connection such that if the anchor connection breaks, the electrical conductor also breaks (at least almost simultaneously). In the case of an anchor rope, for example, the electrical conductor may be integrated in the anchor rope. In case of an anchor chain, the conductor may be guided, for example, through eyelets attached to the chain links.

In particular, the electrical sensor may comprise a generator configured to apply a specific voltage and/or current to the electrical conductor. Furthermore, the electrical sensor may comprise at least one measurement module for detecting, in particular measuring, at least one electrical parameter (e.g., voltage, current, magnetic field, electric field, etc.) resulting from the electrical parameter applied by the generator and the state (e.g., cracked or not cracked) of the electrical conductor.

A breakage of the electrical conductor may cause a detectable change in the at least one detected electrical parameter. In particular, a breakage of the electrical conductor causes a change in the detected electrical parameter such that the detected electrical parameter (value) no longer lies within the specified allowable electrical parameter range.

In particular, the allowable electrical parameter range defines a parameter range of a measured electrical parameter (e.g., voltage, current, magnetic field, electric field, etc.) at which the electrical conductor is intact and not cracked, respectively. In particular, at least one electrical limit parameter value may be predetermined.

As long as the detected electrical parameter values of the at least one detected electrical parameter are within the allowable parameter range, it can be assumed that the at least one anchor connection is intact. A triggering of the switching device by sending a separation instruction does not occur. If, on the other hand, the at least one detected electrical parameter value is outside the allowable parameter range, an event or parameter may be detected that indicates that the at least one anchor connection is (potentially or actually) broken or disconnected (or is immediately at risk of breaking with a high probability (>95%)). Then, the switching device is directly triggered.

Furthermore, an optical sensor arrangement may be provided which may comprise the optical sensor and additionally at least one optical conductor. The offshore structure may comprise the optical sensor arrangement (and in particular the one anchor connection monitored thereby).

In particular, the optical conductor may be a linear state sensor. The optical conductor may comprise at least one optical fibre, which may be surrounded by a protective layer. In particular, the optical conductor may be configured to enable detection of at least one optical parameter that is at least indicative of the mechanical and/or structural condition of the anchor connection.

For example, vibrations (or acoustic emissions) of the anchor connection can be detected. These can then be evaluated to draw conclusions about the mechanical or structural condition of the anchor connection of the offshore structure.

In particular, the optical conductor may be integrated in the anchor connection, for example at least surrounded and enclosed, respectively, by the (outer) sheath of an anchor rope (in radial direction). Alternatively or additionally, the optical conductor can be guided along the anchor connection by guide means (for example eyelets).

Preferably, the optical conductor may extend (as viewed in the longitudinal direction of the anchor connection) along substantially the entire anchor connection. In other words, the at least one optical conductor may preferably extend substantially from a first end of the anchor connection, which is attached to the anchor connection, to the other end of the anchor connection, which other end is connected to or may comprise an anchor (for example, a foundation).

An optical sensor may comprise at least one measurement signal generator. The measurement signal generator may be configured to feed an optical measurement signal into the at least one optical conductor of the anchor connection to be monitored. The sensor may comprise an optical measurement module configured to receive and in particular evaluate a sensor signal generated in response to the optical measurement signal in the optical conductor. In particular, the sensor signal can be based on the measurement signal and the state of the optical conductor and thus the state of the anchor connection (e.g., cracked or not cracked). By evaluating the sensor signal, a broken anchor connection can be detected.

The optical sensor may be operated in particular according to the OTDR method. For example, the measurement signal generator can feed at least one light pulse, in particular laser pulses, (with a duration between, for example, 3 ns to 20 μs) into the optical conductor as the measurement signal. The backscattered light can be measured over time as the sensor signal, in particular by the measuring module. The (continuously) detected optical parameter can in particular be the sensor signal, for example in the form of a detected reflection parameter, such as a backscattered light parameter or a parameter determined therefrom.

The optical conductor may be attached to the anchor connection in such a way that if the anchor connection breaks, the optical conductor also breaks (at least almost simultaneously). A breakage of the optical conductor may cause a detectable change of the at least one optical parameter. In particular, a breakage of the optical conductor causes a change of the detected optical parameter in such a way that the detected optical parameter (value) is no longer within the predetermined allowable optical parameter range.

In particular, the allowable optical parameter range defines an optical parameter range in which the optical conductor and thus the at least one anchor connection are intact or are not cracked. In particular, at least one optical limit parameter value may be predetermined.

As long as the detected optical parameter values of the at least one detected optical parameter are within the allowable parameter range, it can be assumed that the at least one anchor connection is intact. Triggering of the switching device by sending a separation instructions does not occur. If, on the other hand, the at least one detected optical parameter value is outside the allowable parameter range, an event or parameter can be detected that indicates that the at least one anchor connection is (potentially or actually) broken (or is immediately threatening to break with a high probability (>95%)).

In particular, an optical evaluation module can be configured to (continuously) compare the detected optical parameter values with the allowable parameter range. If it is determined that the detected parameter values are outside the allowable position range, the switching device can be triggered.

Alternatively or additionally, a mechanical sensing arrangement may be provided comprising the mechanical sensor and at least one measuring rope. The measuring rope may, for example, extend from one end of the anchor connection to the other end of the anchor connection and, in particular, may extend in parallel along the anchor connection.

The measuring rope can be attached to the anchor connection in such a way that if the anchor connection breaks, the measuring rope also breaks. Before breaking, the measuring rope tension detectable by the mechanical sensor and/or the distance of movement of the measuring rope detectable by the mechanical sensor may change, in particular due to the broken anchor connection. This can be detected by the mechanical sensor and evaluated by a mechanical evaluation module. In particular, a breakage of the anchor connection causes a detectable change in the detected mechanical parameter such that the detected mechanical parameter (value) is no longer within the specified allowable optical parameter range.

In particular, the allowable mechanical parameter range defines a parameter range (e.g., a maximum allowable stress range, a maximum allowable movement range, etc.) at which the at least one anchor connection is intact or has not broken. In particular, at least one optical limit parameter value (e.g., stress limit value, movement distance limit value) may be specified.

As long as the detected mechanical parameter values of the at least one detected mechanical parameter is within the allowable parameter range, it can be assumed that the at least one anchor connection is intact. Triggering of the switching device by sending a separation instructions does not occur. If, on the other hand, the at least one detected mechanical parameter value is outside the allowable parameter range, an event or parameter can be detected that indicates that the at least one anchor connection is (potentially or actually) broken (or is immediately at risk of breaking with a high probability (>95%)).

The mechanical evaluation module can be configured in particular to (continuously) compare the detected mechanical parameter values with the allowable parameter range. If it is determined that the detected parameter values are outside the allowable parameter range, the switching device can be triggered (immediately) in the manner described.

A further aspect of the application is a messenger line arrangement. The messenger line arrangement comprises at least one buoy (associated with a (previously described) offshore structure. The messenger line arrangement comprises at least one (previously described) messenger line, wherein a first end of the messenger line is fixable to a submarine power cable and a further end of the messenger line is fixed to the buoy.

A further aspect of the application is a submarine power cable arrangement. The submarine power cable arrangement comprises at least one (previously described) submarine power cable. The submarine power cable arrangement comprises at least one (previously described) messenger line, in particular at least one (previously described) messenger line arrangement. The first end of the messenger line is fixed to the submarine power cable.

A still further aspect of the application is a power generation system. The power generation system comprises at least one (previously described) offshore structure. The power generation system comprises at least one (previously described) submarine power cable arrangement.

In particular, a power generation system comprises two or more submarine power cable arrangements and/or two or more offshore structures.

Preferably, the power generation system may be a floatable offshore wind power system that is capable of floating in the installed state. In particular, a floatable offshore wind power system may comprise two or more floatable wind turbines connected via submarine power cables. Also, the power generation system may be a floatable offshore photovoltaic system that is capable of floating in the installed state or a floatable offshore hydrogen production system that is capable of floating in the installed state. It shall be understood that the aforementioned systems may be combined. For example, an offshore wind energy system may include at least one photovoltaic device and/or at least one hydrogen production device.

The features of the offshore structures, messenger line arrangements, submarine power cable arrangements and power generation systems can be freely combined with one another. In particular, features of the description and/or the dependent claims, even when the features of the dependent claims are completely or partially avoided, may be independently inventive in isolation or freely combinable with one another.

### BRIEF DESCRIPTION OF THE DRAWINGS

These and other aspects of the present patent application become apparent from and will be elucidated with reference to the following figures. The features of the present application and of its exemplary embodiments, as presented above, are understood to be disclosed also in all possible combinations with each other.

In the figures show:

FIG. 1 shows a schematic view of an embodiment of an offshore structure according to the present application,

FIG. 2 shows a schematic view of a further embodiment of an offshore structure according to the present application,

FIG. 3a shows a schematic view of a further embodiment of an offshore structure according to the present application in a normal operation state,

FIG. 3b shows a schematic view of the embodiment of FIG. 3a in an state with a broken submarine power cable,

FIG. 4 shows a schematic view of a further embodiment of an offshore structure according to the present application,

FIG. 5 shows a schematic view of a further embodiment of an offshore structure according to the present application,

FIG. 6 shows a schematic view of a further embodiment of an offshore structure according to the present application,

FIG. 7 shows a schematic view of a further embodiment of an offshore structure according to the present application, and

FIG. 8 shows a schematic view of a further embodiment of an offshore structure according to the present application.

### DETAILED DESCRIPTION OF THE INVENTION

Like reference signs in different figures indicate like elements. In addition, z denotes the vertical direction and x denotes a horizontal direction.

In the following embodiments, offshore wind turbines are depicted as offshore structures. However, the following explanations can be transferred to other offshore structures, such as offshore photovoltaic structures, offshore hydrogen production structures, etc.

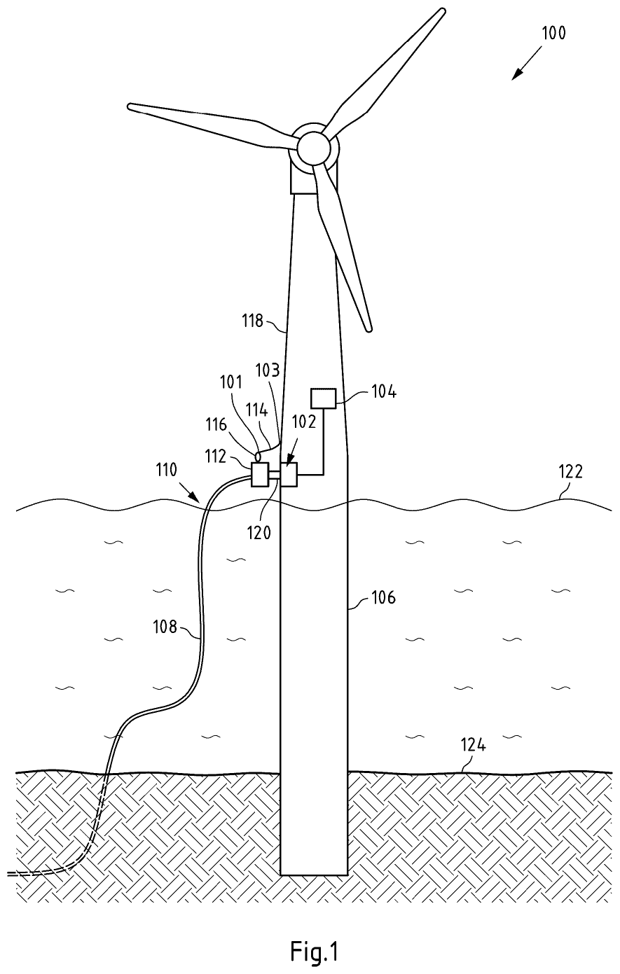

FIG. 1 shows a schematic view of an embodiment of an (non-floatable) offshore structure 100 according to the present application.

The offshore structure 100 comprises a foundation 106 (e.g. a monopile anchored in the seabed 124) configured to support an offshore device (e.g. turbine tower with nacelle, etc.) comprising at least one electrical device 104 (e.g. a generator). The offshore device is in particular an electrical power generation device which in the present example is a wind turbine. The wind turbine is configured to convert the kinetic energy of the wind into electrical energy. The electrical device 104 is electrically connected to at least one submarine cable connector 102.

In the shown installation state of the offshore structure 100, a submarine power cable 108 (e.g. a medium or high voltage cable) is connected to the submarine cable connector 102 via a cable connector 112 in form of the plug 112 of the submarine power cable 108. In the present example, the generated electrical energy can be fed from the electrical device 104 into the submarine power cable 108 via the submarine cable connector 102. An energy flow can alternatively or additionally occur in the opposite direction.

In the present embodiment, the plug 112 may comprise a weak link 120. In other variants, the weak link can also be arranged downstream the plug 112. The weak link 120 serves to provide a defined area of rupture when a force applied to the submarine cable 108 is large enough to cause the submarine cable 108 to break.

For example, submarine power cable 108 may comprise three phase conductors for transmitting electrical power. Further, at least one optical fibre may be integrated in the submarine power cable 108 as an (optical) communication conductor. It shall be understood that a submarine power cable 108 may include further cable elements, such as at least one insulation layer, at least one shielding layer, at least one armoring layer, an outer jacket, filler material, and/or the like.

According to the present application, the offshore structure comprises at least one messenger line 114, e.g. made of steel and/or fiber-reinforced plastics, in particular carbon-fiber-reinforced polymers, glass-fiber-reinforced polymers and/or aramid-fiber-reinforced polymers.

The first end 101 of the messenger line 114 is fixed to the submarine power cable 108 and the further end 103 of the messenger line 114 is fixed to the offshore structure 100.

Preferably, the first end 101 of the messenger line 114 is fixed to the submarine power cable 108 downwards and behind, respectively, the weak link 120 (starting from the submarine cable connector 102). In particular, the first end 101 of the messenger line 114 is fixed in a first end area 110 of the submarine power cable 108, wherein the (cable) length of the end area 110 is in particular between 0 m and 40 m, particularly preferred between 0 m and 20 m (starting from the submarine cable connector 102).

In the present embodiment, the first end 101 of the messenger line 114 is fixed to the plug 112 via at least one fixing module 116. In the present exemplified case, the fixing module is an eyelet 116. It shall be understood that in other variants, the fixing module may be at least one eyelet attached to the submarine power cable, in particular, the cable sheath, at least one additional sheath in which the first end of the messenger line is integrated or at least one Chinese finger in which the first end of the messenger line is integrated.

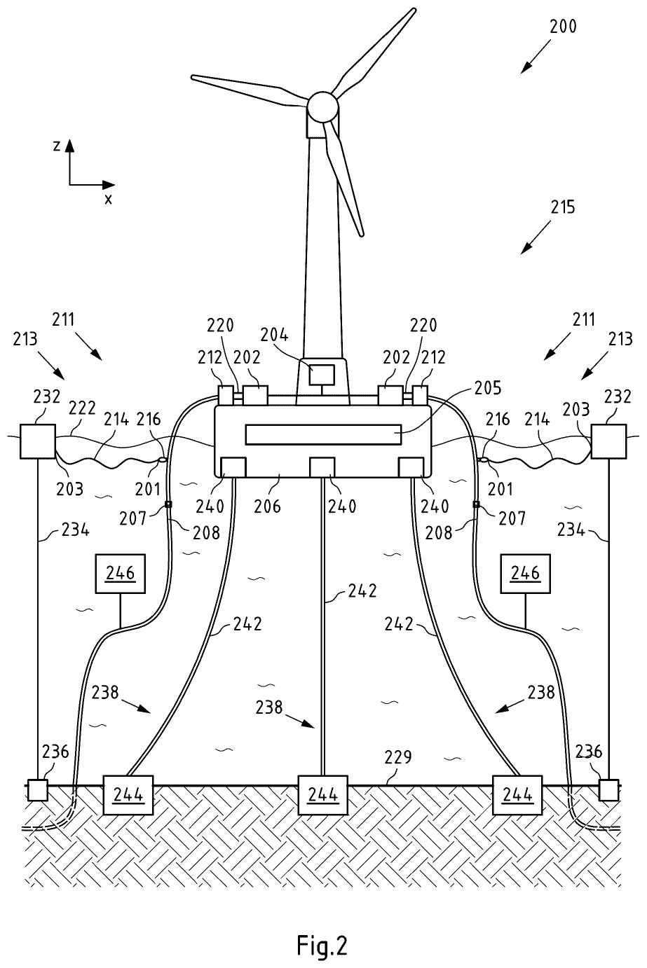

As already described, the further end 103 of the messenger line 114 is fixed to the offshore structure, in particular, a structure component 106, 118. In the present case, the further end 103 of the messenger line 114 is fixed to the foundation 106 of the offshore structure 100, in particular a foundation wall 118, for instance, via an eyelet. In other variants of the application, other fixing modules can be used to fix the further end 103 of the messenger line 114 to a structure component. In addition, in other variants of the application the further end 103 of the messenger line 114 may be fixed to another structure component, such as a hang-off of the offshore structure 100, an airtight deck of the offshore structure 100, a hollow structure (e.g. J-tube) configured to guide the submarine power cable from the submarine cable connector along the offshore structure or at least one buoy (see e.g. FIG. 2) at least associated with the offshore structure 100.

By providing a messenger line 114, it is achieved that there will be still a link between the offshore structure 100 and the submarine power cable 108 when the submarine power cable 108 has been broken.

It is noted that reference sign 122 denotes the average waterline.

FIG. 2 shows a schematic view of a further embodiment of an (floatable) offshore structure 200 according to the present application. In order to avoid repetitions, in the following only the differences between the embodiment of FIG. 1 and the embodiment of FIG. 2 are essentially described. With regard to the other elements of the offshore structure 200 it is referred to the previous embodiment.

In this embodiment, the offshore structure 200 shown in the installed state is a floatable offshore structure 200. Presently, the offshore structure 200 comprises a floatable foundation 206 having at least one floating body 205.

As can be seen, the shown offshore wind turbine 200 comprises two submarine cable connectors 202, to each of which a submarine power cable 208 is connected. A submarine power cable 208 extends in the present example from a submarine cable connector 202 preferably in an S-shape to the surface of the seabed 224. For this purpose, at least one buoyancy body 246 may be provided and in particular attached to the submarine power cable 208.

As further indicated in FIG. 2, the at least one submarine power cable 208 is laid in the subsea bottom 224 with a specific depth range and extends in particular to a further structure (not shown herein) of the power generation system 215, such as a further buoyant or non-buoyant offshore structure or an onshore structure.

The power generation system 215 comprises the at least one offshore structure 200 and at least one submarine cable arrangement 213. The submarine cable arrangement 213 may comprise at least one messenger line 213 and at least one submarine power cable 208.

In addition, the floatable offshore structure 200 comprises at least one anchor connector 240. In the present example, three anchor connectors 240 are provided. In the present embodiment, an anchor connection 242 is attached to each anchor connector 240. In particular, the anchor connection 242 is part of a mooring arrangement 238. The offshore structure 200 may comprise the at least one mooring arrangement 238.

In particular, a mooring arrangement 238 comprises at least one anchor connection 242 and an anchor 244. In the illustrated installation and operating condition of the floatable offshore structure 200, the anchor 244 of the mooring arrangement 238 is at least partially anchored in the subsea floor 224. A first end of the anchor connection 242 is attached to the anchor connector 240 and the other end of the anchor connection 242 is attached to the anchor 244.

Further, the offshore structure 200 comprises at least one messenger line 214, presently two messenger lines 214. The respective first end 201 of the respective messenger line 214 is fixed to the respective submarine power cable 208 (e.g. via an eyelet 216 attached to the cable sheath in the cable end area) and a respective further end 203 of the respective messenger line 214 is (indirectly) fixed to the offshore structure 200.

In the present example, at least one buoy 232 (for example for each submarine power cable 208 a respective buoy 232) is provided which is associated to the offshore structure 200. This means in particular that the at least one buoy 232 is permanently within a specific vicinity (e.g. with a radius of x meters) to the (installed) offshore structure 200 at the installation site. In particular, the offshore structure 200 comprises the at least one buoy 232.

As can be seen, the further end 203 of a messenger line 214 is fixed to a buoy 232. Each buoy 232 may be anchored to the seabed via a buoy rope (or chain) 234 and a buoy anchor 236. It shall be understood that other fixing means can be used. It shall be further understood that only one buoy might be provided for two or more submarine power cables.

A messenger line arrangement 211 comprises the at least one buoy 232 and the at least one messenger line 214.

Furthermore, the at least one submarine power cable 208 can be provided with a (previously described) tracking transmitter 207, preferably arranged downwards of the fixing point of the further end 203 of the messenger line 214 (starting from the connector 202).

It shall be noted that according to variants of the application, optionally at least one (not shown) inflatable floating body with at least one inflatable bag configured to inflate upon a receipt of a triggering instruction can be attached to the submarine power cable, as described hereinbefore.

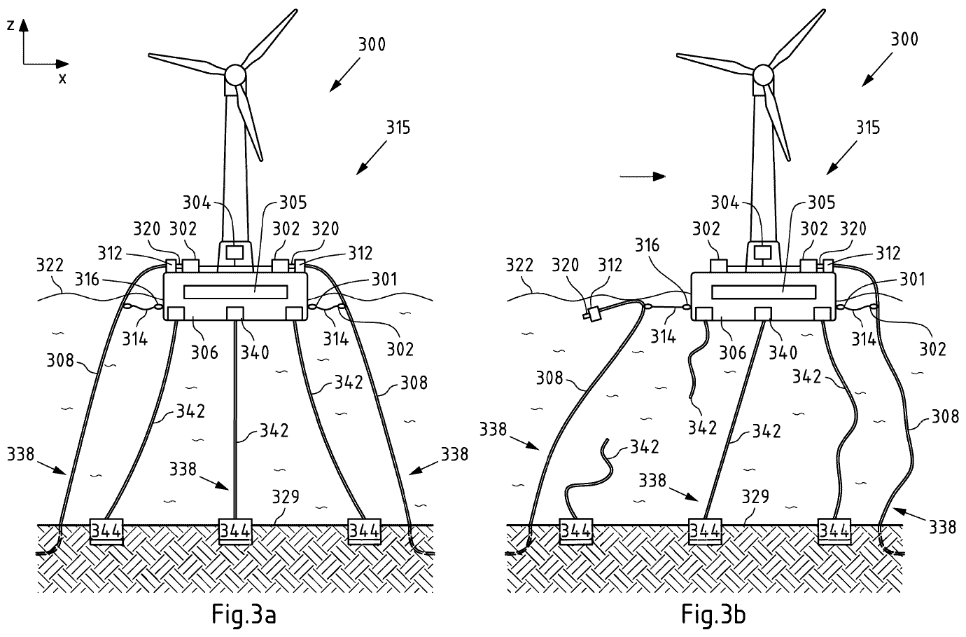

FIG. 3a shows a schematic view of a further embodiment of an offshore structure 300 according to the present application in a normal operation state, i.e. no breakage of a submarine power cable 308 has occurred.

The depicted embodiment is similar to the embodiment of FIG. 2. The main difference is that the respective messenger lines 314 are not connected to a buoy associated with the floatable offshore structure 300. Instead, the respective further ends 303 of the respective messenger lines 314 are connected to the floating foundation 306 (wall).

FIG. 3b shows the embodiment of FIG. 3b in a state with a broken submarine power cable 308. As can be seen from the FIG. 3b, due to a broken anchor connection 342, at least one submarine power cable 308 of the floatable offshore structure 300 is broken (at the weak link). Due to the broken anchor connection 342, the floatable offshore structure may drift (indicated by the arrow) from its original installation position (shown in FIG. 3a) to a drifted position shown in FIG. 3b.

The length of the at least one messenger line 314 of the floatable offshore structure 300 is preferably designed such that it is at least greater than a maximum distance of movement of the floatable offshore structure that can maximally occur when one anchor connection 342 of a plurality of anchor connections 342 of the floatable offshore structure 300 is broken.

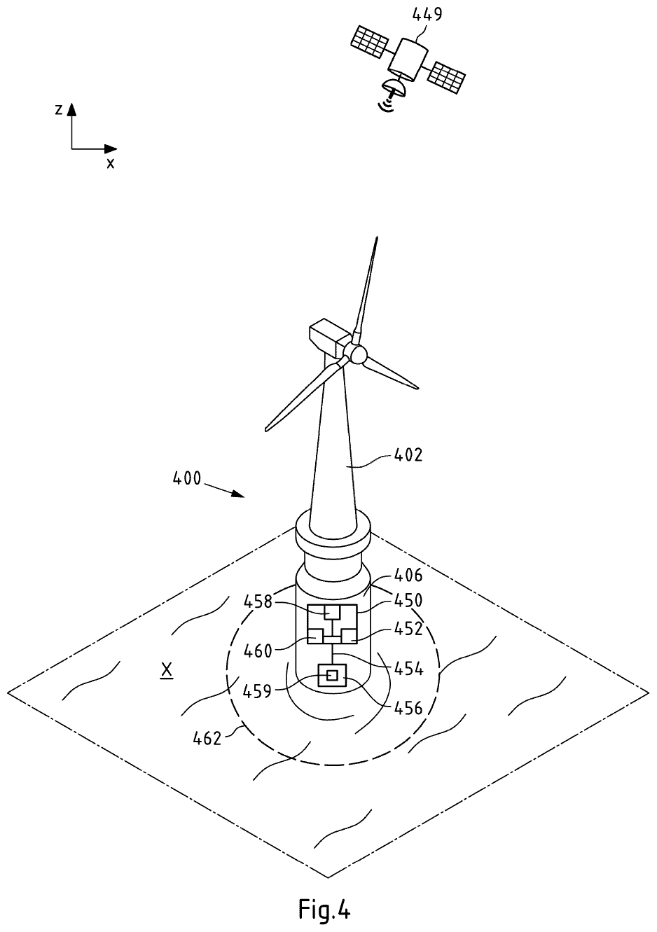

FIG. 4 shows a schematic view of a further embodiment of an offshore structure 400 according to the present application. In order to avoid repetitions, in the following only the differences between the previous embodiments and the embodiment of FIG. 4 is essentially described. In particular, it is noted that certain details of the floatable offshore structure 400, such as submarine power cable, messenger line, anchor connection, etc., have been omitted in favor of a better overview.

A detection arrangement 450 of the floatable offshore structure 400 comprises at least one position sensor 458, at least one position evaluation module 460, and at least one memory module 452. The at least one position sensor 458 is in particular configured to detect (in particular measure) the (instantaneous) geographic position of the floatable offshore structure 400. The at least one position sensor 458 is in particular a satellite-based position sensor 458 (e.g., GPS sensor, Galileo sensor, etc.). Satellites 449 may transmit encoded signals continuously. From the information contained in the signals, the position sensor 458 may calculate the instantaneous position of the floatable offshore structure 400.

In particular, the at least one position sensor 458 is configured to substantially continuously detect or calculate the instantaneous position of the buoyant offshore structure 400.

The position evaluation module 460 may be configured to evaluate the detected position, in particular to detect the presence of an anchor connection break indication. In particular, the detection of an anchor connection break indication is based on the detected geographic position and a predetermined allowable geographic position range of the floatable offshore structure 400. In particular, this position range and the corresponding position data, respectively, may be stored in the memory module 452. The memory module 452 may be accessed by the position evaluation module 460.

In particular, the allowable geographic position range is the maximum possible range of movement in which the floatable offshore structure 400 can maximally move in the installation state of the floatable offshore structure 400 without an anchor connection being broken. This range is indicated by the dashed line 462 in FIG. 4. In particular, if one anchor connection, for example, of a plurality of anchor connections, breaks, then the maximum possible range of movement of the floatable offshore structure 400 increases, so that the floatable offshore structure 400 may be outside of the area 462. A position monitoring system can therefore be used to reliably detect an anchor connection break indication.

In particular, the allowable position range may depend on parameters such as the length of the at least one anchor connection, the number of connected anchor connections, a provided length buffer of the at least one submarine power cable, and/or the like. For example, the longer the anchor connections or the greater the water depth at the installation site of the offshore structure 400, the greater the maximum range of motion of a floatable offshore structure 400.

The submarine power cable may have a corresponding length buffer, such as having an S-shaped path as shown in FIG. 2. With an offshore structure 400 moving within the maximum range of movement, it can be ensured that the submarine power cable is not damaged.

The detected geographic position, in particular in the form of geographic coordinates (e.g., GPS data), are presently (continuously) provided to the position evaluation module 460. The position evaluation module 460 may (continuously) compare the provided position data with the allowable position range, which may also be defined by position data.

If the detected position data is within the allowable position range or satisfies the allowable position range (i.e., the offshore structure 400 is positioned within the range 462), it may be determined that the at least one anchor connection is intact. Triggering of a switching device 456 does not occur.

If, on the other hand, the position data of the offshore structure 400 is outside of the allowable position range (in which case the offshore structure 40 is positioned outside of the range 462, for example at position X), an event or parameter may be detected that indicates that the at least one anchor connection is (potentially or actually) broken or disconnected (or is imminently likely to break).

If it is determined that the detected position of the floatable offshore structure 400 is outside the allowable position range, the switching device 456 can preferably be immediately triggered and actuated, respectively. Upon detection, in particular, directly upon a detection of an anchor connection break indication, at least an electrical disconnecting of the electrical connection to the submarine power cable is performed by the switching device 456. Preferably, a corresponding electrical disconnecting is performed for all submarine power cables connected to the offshore structure 400. In other words, the at least one submarine power cable is de-energized. I

In particular, in addition to the electrical disconnecting by the switching device 456, the switching device can mechanically disconnect the at least one submarine power cable upon the described detection of an anchor connection break indication.

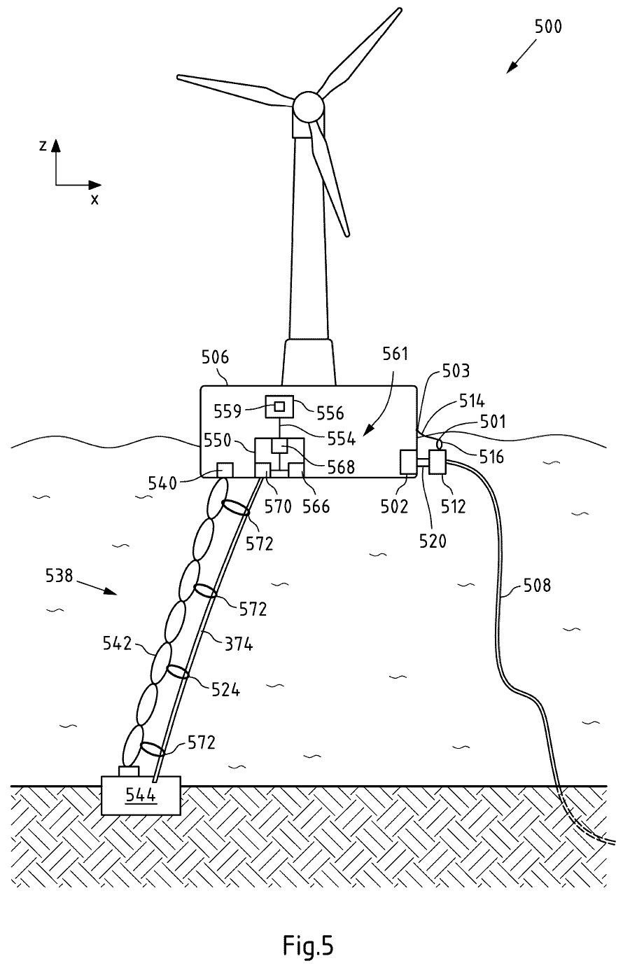

FIG. 5 shows a schematic view of a further embodiment of a floatable offshore structure 500 according to the present application. To avoid repetition, essentially only the differences from the embodiments already shown are described below. Otherwise, reference is made to the explanations of FIGS. 1 to 4. In particular, it is noted that for the sake of a better overview, certain details have been omitted. By way of example, only one mooring arrangement 538 and only one submarine power cable 508 have been shown for ease of reference.

The shown floatable offshore structure 500 comprises a detection arrangement 550. In the present case, an electrical sensor 561 formed by the electrical detection arrangement 550 and an electrical evaluation module 568 may be provided. In particular, the electrical sensor 561 comprises a generator 566 and a measurement module 570.

As an anchor connection 542, an anchor chain 542 is provided as an example in the present application. In variants of the application, an anchor rope may also be provided as the anchor connection.

Furthermore, in the present embodiment, an electrical sensor arrangement may be provided, which may be formed by the electrical sensor 561 and at least one electrical (measuring) conductor 574. The floatable offshore structure 500 may comprise the at least one electrical sensor and/or the at least one mooring arrangement 538.

The electrical conductor 574 may be at least partially guided along the anchor connection 542. As can be seen from FIG. 5, in the present case the electrical conductor 574 is guided along the entire length of the anchor connection 542, i.e. from the first end of the anchor connection 542 connected to the anchor connector 540 to the other end of the anchor connection 542 connected to the anchor 544. In particular, a plurality of eyelets 572 may be disposed on the anchor connection 542 for this purpose. The electrical conductor 574 may be guided through the eyelets 572, wherein a first end of the electrical conductor 574 may be connected to the detection arrangement 550 and the other end of the electrical conductor 574 may be connected to the anchor 544. In particular, the other end of the electrical conductor 574 may extend into the anchor 544 such that if the electrical conductor 574 is disconnected from the anchor 544, a portion of the electrical conductor 574 always remains in the anchor 544.

The electrical conductor 574 may comprise an insulation in the form of a protective layer and, in particular, a forward line and a return line that are electrically insulated from each other. The first end of the forward line may be connected to the generator 566, the other end of the electrical conductor 574 may be connected to the other end of the return line, and the first end of the return line may be connected to the generator 566, so that in particular a closed circuit is formed. Further, the measurement module 570 may be coupled to the first ends of the forward line and the return line to measure an electrical parameter.

In particular, the generator 566 is configured to apply a particular voltage and/or current to the electrical conductor 572. For example, a particular voltage may be applied to the forward line and the return line. In particular, the measurement module 570 is configured to detect, in particular measure, at least one electrical parameter (e.g., voltage, current, magnetic field, electric field, etc.) present at the electrical conductor 574. For example, the measurement module 570 may measure current.

In particular, if there is a breakage of the anchor connection 542, then the electrical conductor 574 also breaks. The breakage of the electrical conductor 574 may result in a measurable change in the electrical parameter present at the electrical conductor 574. In particular, an allowable electrical parameter range may be predetermined. This may in particular depend on the (predetermined) electrical parameter, the resistance of the electrical conductor 574 and/or the length of the electrical conductor 574.

The allowable electrical parameter range may define a parameter range at which the at least one anchor connection 542 is intact. As long as the detected electrical parameter values of the at least one detected electrical parameter are within the allowable parameter range, for example, if the detected electrical parameter value does not exceed (or fall below) a limit parameter value, it can be assumed that the at least one anchor connection 542 is intact. On the other hand, if the at least one detected electrical parameter value is outside the allowable parameter range, for example, if the detected electrical parameter value exceeds (or falls below) the limit parameter value, an event or parameter may be detected that indicates that the at least one anchor connection 542 is (potentially or actually) broken (or is imminently likely to break). Then, the switching device 556 may be triggered in the manner described above.

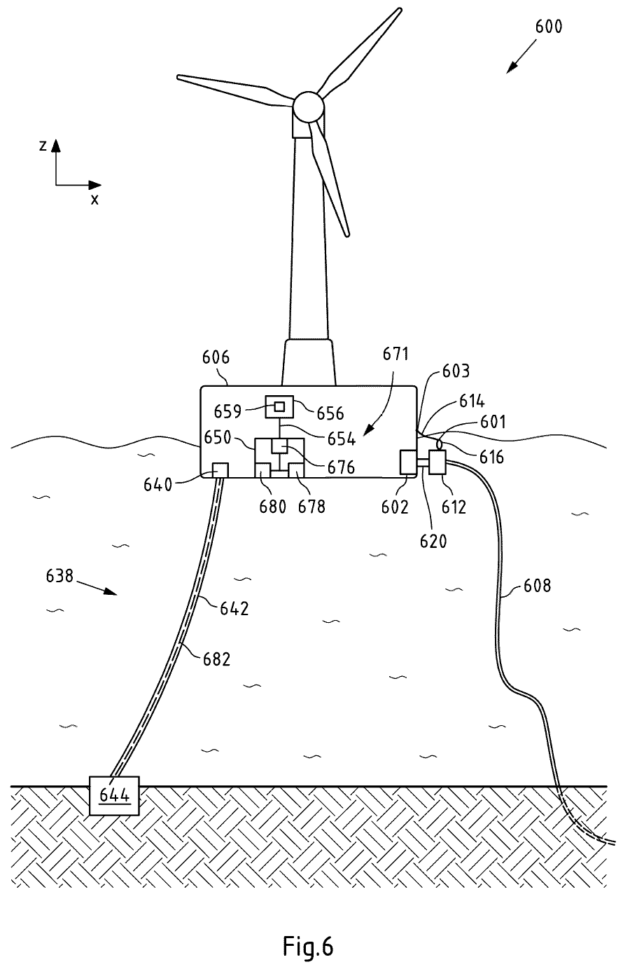

FIG. 6 shows a schematic view of a further embodiment of a floatable offshore structure 600 according to the present application. To avoid repetition, essentially only the differences from the embodiments already shown are described below. Otherwise, reference is made to the explanations of FIGS. 1 to 5. In particular, it is noted that for the sake of a better overview, certain details have been omitted. By way of example, only one mooring arrangement 638 and only one submarine power cable 608 have been shown for ease of reference.

In particular, an optical sensor 671 is provided as the anchor connection structure sensor instead of an electrical sensor as in FIG. 5.

In the present embodiment, the optical sensor 671 formed by an optical detection arrangement 650 comprises a measurement signal generator 680 and a measurement module 678. In addition, the detection arrangement 650 may comprise an optical evaluation module 676.

Furthermore, in the present case, the at least one anchor connection 642 is formed as an anchor rope 642. An optical conductor 682 may be integrated in the anchor rope 642. As can be seen, the shown optical conductor 682 extends from the first end of the anchor rope 642 attached to the anchor connector 640 to the other end of the anchor rope 642 attached to the anchor 644. In particular, the first end of the optical conductor 682 may be coupled to the sensor 671. Sensor 671 and optical conductor 682 may form an optical sensor arrangement. In particular, the other end of the optical conductor 682 may extend into the anchor 644 such that if the optical conductor 682 is broken from the anchor 644, a portion of the optical conductor 682 always remains in the anchor 644.

The measurement signal generator 680 is presently configured to feed an optical measurement signal into the at least one optical conductor 682 of the anchor connection 642 to be monitored. The optical measurement module 678 is presently configured to receive and, in particular, evaluate the sensor signal generated in response to the optical measurement signal in the optical conductor 682. In particular, the evaluation may be based on the measurement signal and the sensor signal that caused the measurement signal to determine whether or not an anchor connection 642 is broken.

The illustrated optical evaluation module 676 may be configured to detect the broken anchor connection 642 based on the at least one detected optical parameter and at least one predetermined allowable optical parameter range.

In particular, the optical sensor 671 is operated in accordance with the OTDR method. For example, the measurement signal generator 680 can feed at least one laser pulse (with a duration between, for example, 3 ns to 20 μs) into the optical conductor 682 as a measurement signal. The backscattered light can be measured over time as the sensor signal, in particular by the measurement module 678. The time dependence of the sensor signal can, for example, be converted into a location dependence, so that a spatially resolved determination of the mechanical structural state of the anchor connection 642 (for example, based on the vibration data, sound data, etc., obtained from the measurement signal) can be made. In particular, the (continuously) detected optical parameter is the sensor signal and may be, for example, a detected reflection parameter, such as a backscattered light parameter or a parameter determined therefrom.

The optical conductor 682 may be attached to the anchor connection 642, in particular integrated, in such a way that if the anchor connection 642 breaks, the optical conductor 682 also breaks (simultaneously). A breakage of the optical conductor 682 may cause a detectable change of the at least one detected optical parameter. In particular, a breakage of the optical conductor 682 causes a change of the detected optical parameter such that the detected optical parameter (value) is no longer within the predetermined allowable optical parameter range.

In particular, the allowable optical parameter range defines a parameter range at which the at least one anchor connection 642 is intact. In particular, at least one optical limit parameter value may be predetermined.

As long as the detected optical parameter values of the at least one detected optical parameter lie within the allowable parameter range, i.e. in particular do not exceed (or fall below) the optical limit parameter value, it can be assumed that the at least one anchor connection 642 is intact. If, on the other hand, the at least one detected optical parameter value is outside the allowable parameter range, it can be assumed or an event can be detected, for example, if the optical limit parameter value is exceeded (or fallen below), that the at least one anchor connection 642 is (potentially or actually) broken (or is immediately at risk of breaking with a high probability). Then, the switching device 656 may be triggered in the manner described above (see e.g. FIG. 4).

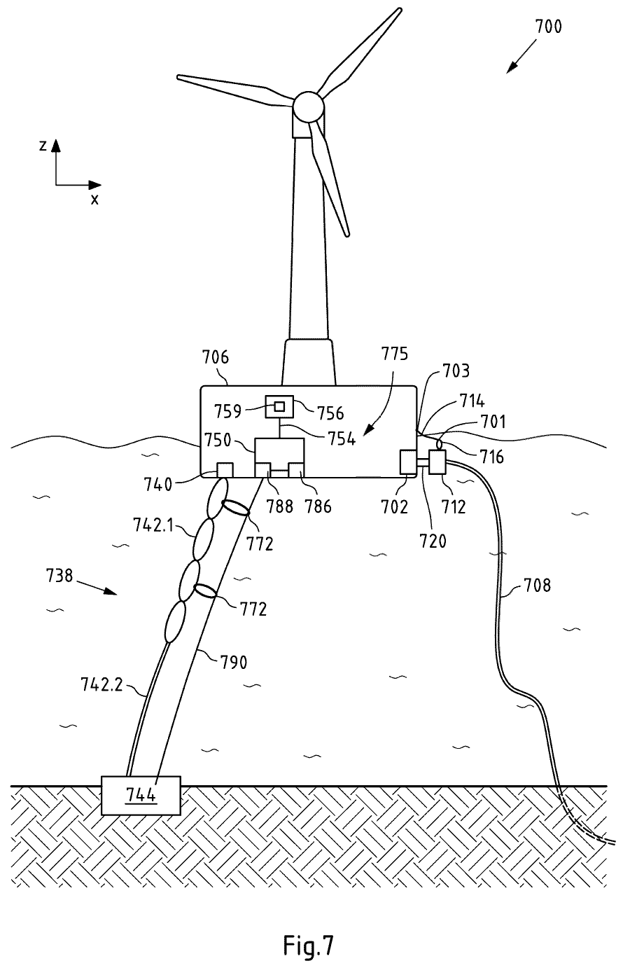

FIG. 7 shows a schematic view of a further embodiment of a floatable offshore structure 700 according to the present application. To avoid repetitions, essentially only the differences from the embodiments already shown are described below. Otherwise, reference is made to the explanations of FIGS. 1 to 6. In particular, it is noted that for the sake of a better overview, certain details have been omitted. Also, by way of example, only one mooring arrangement 738 and only one submarine power cable 708 have been shown for ease of reference.

In particular, in the illustrated embodiment, as an anchor connection structure sensor, a mechanical sensor 775 is provided instead of an electrical sensor, as in FIG. 5, or an optical sensor, as in FIG. 6. In variants of the application, a plurality of different sensors may be provided.

In the present example, the anchor connection is a combination of an anchor chain 742.1 and an anchor rope 742.2. A measuring rope 790 is guided along the entire length of the anchor connection 742.1, 742.2 according to the preferred embodiment shown, for example using eyelets 772 as guide elements. The first end may be coupled to the mechanical sensor 775. Sensor 775 and measuring rope 790 may form a mechanical sensor. The other end of the measuring rope 790 may be attached to the anchor 744.

In the present case, the mechanical sensor 775 formed by a mechanical detection arrangement 750 may comprise a mechanical sensor module 788 coupled to the measuring rope 790. In particular, the mechanical sensor module 788 is configured to detect at least one mechanical parameter of the measuring rope 790.

The detection arrangement 750 further comprises, in the present embodiment, at least one mechanical evaluation module 786. The mechanical evaluation module 786 may be configured to detect a broken anchor connection 742.1, 742.2 based on the at least one detected mechanical parameter and at least one predetermined allowable mechanical parameter range.

The measuring rope 790 may be attached to the anchor connection 742.1, 742.2 such that when the anchor connection 742.1, 742.2 breaks, the measuring rope 790 also breaks. Prior to a breakage of the measuring rope 790, the measuring cable tension detectable by the mechanical sensor module 788 and/or the distance of movement of the measuring rope 790 detectable by the mechanical sensor module 788 may change, in particular due to the broken anchor connection 742.1, 742.2. This can be detected by the mechanical sensor module 788 and evaluated by the mechanical evaluation module 786. In particular, a breakage of the anchor connection 742.1, 742.2 causes a change of the detected mechanical parameter in such a way that the detected mechanical parameter (value) is no longer within the predetermined allowable optical parameter range.

In particular, the allowable mechanical parameter range defines a parameter range (e.g., a maximum allowable stress range, a maximum allowable movement range, etc.) at which the at least one anchor connection 742.1, 742.2 is intact. In particular, at least one mechanical limit parameter value (e.g., stress limit value, movement distance limit value) may be predetermined.

As long as the detected mechanical parameter values of the at least one detected mechanical parameter are within the allowable parameter range, i.e. in particular the limit parameter value is not exceeded (or fallen below), it can be assumed that the at least one anchor connection 742.1, 742.2 is intact. If, on the other hand, the at least one detected mechanical parameter value is outside the allowable parameter range, i.e., if, for example, the limit parameter value is exceeded (or fallen below), an event or parameter can be detected that indicates that the at least one anchor connection 742.1, 742.2 is (potentially or actually) broken (or is immediately at risk of breaking with a high probability). Then, preferably, the switching device 756 may be immediately triggered as previously described.

The described embodiments of FIGS. 1 to 7 can be combined with each other. For example, the embodiment example of FIG. 4 can be combined with an embodiment example of FIGS. 5 to 7.

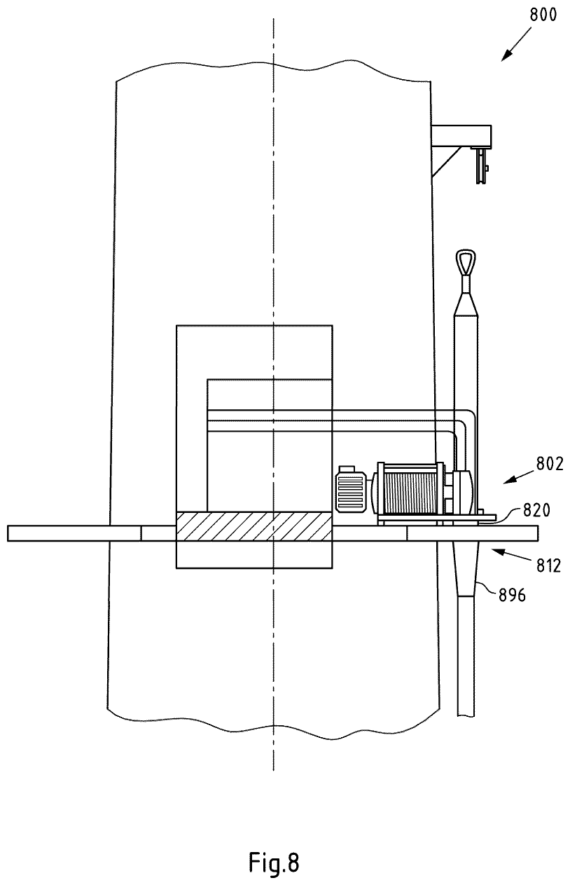

FIG. 8 shows a detailed schematic partial view of a further embodiment of an offshore structure 800 according to the application. For a better overview, details, such as the messenger line, have been omitted.

As can be seen from FIG. 8, the offshore structure 800 comprises an submarine cable connector 802 coupled with a plug 812 of the submarine power cable, which is guided through a hollow structure (e.g. a J-tube) from the submarine cable connector 802 towards the seabed. Furthermore, the already described weak link 820 is shown. In the present example, the weak link may be arranged at the hang-off of the offshore structure.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. Offshore structure, comprising:
at least one submarine cable connector configured to connect a submarine power cable of the offshore structure to at least one electrical device of the offshore structure, and
at least one messenger line,
wherein a first end of the messenger line is fixed to the submarine power cable and a further end of the messenger line is fixed to the offshore structure, wherein
the submarine power cable comprises a weak link in the end area of the first end of the submarine power cable, wherein the first end of the messenger line is fixed to the submarine power cable downstream the weak link starting from the submarine cable connector of the offshore structure, wherein the weak link is an area of the submarine power cable that is mechanically and/or structurally configured in such a way that the tensile strength at said weak link is lower than in the remaining cable area of the submarine power cable.

2. Offshore structure according to claim 1, wherein
the first end of the messenger line is fixed to the submarine power cable in an end area of a first end of the submarine power cable which is connected to the submarine cable connector,
wherein the length of the end area is between 0 m and 40 m.

3. Offshore structure according to claim 1, wherein
the first end of the messenger line is fixed to the submarine power cable at a cable connector of the submarine power cable.

4. Offshore structure according to claim 1, wherein
the first end of the messenger line is fixed to the submarine power cable via at least one fixing module, wherein the at least one fixing module is selected from the group, comprising:
at least one eyelet attached to the cable connector,
at least one eyelet attached to the submarine power cable,
at least one additional sheath in which the first end of the messenger line is integrated, and
at least one Chinese finger in which the first end of the messenger line is integrated.

5. Offshore structure according to claim 1, wherein
the further end of the messenger line is fixed to the offshore structure at at least one structure component, wherein the at least one structure component is selected from the group, comprising:
a hang-off of the offshore structure,
an airtight deck of the offshore structure,
a hollow structure configured to guide the submarine power cable from the submarine cable connector along the offshore structure,
a foundation of the offshore structure,
at least one buoy at least associated with the offshore structure.

6. Offshore structure according to claim 1, wherein
the messenger line is made of a material selected from the group, comprising:
metal,
plastics,
fiber-reinforced plastics.

7. Offshore structure according to claim 1, wherein
the submarine power cable comprises at least one tracking transmitter.

8. Offshore structure according to claim 1, wherein
the length of the at least one messenger line of the floatable offshore structure is at least greater than a maximum distance of movement of the floatable offshore structure that can maximally occur when one anchor connection of a plurality of anchor connections of the floatable offshore structure is broken.

9. Offshore structure according to claim 1, wherein
the offshore structure is a floatable offshore structure, wherein the floatable offshore structure further comprises:
at least one anchor connector configured to connect at least one anchor connection for anchoring the floatable offshore structure to a subsea floor,
at least one detection arrangement configured to detect an anchor connection break indication, and
at least one switching device configured to at least electrically disconnect the electrical connection to the submarine power cable connected to the submarine cable connector upon or after a detection of the anchor connection break indication.

10. Offshore structure according to claim 9, wherein
the detection arrangement comprises at least one position sensor configured to detect the position of the floatable offshore structure, and
the detection arrangement comprises at least one position evaluation module configured to detect the anchor connection break indication based on the detected position and a predetermined allowable position range.

11. Offshore structure according to claim 9, wherein
the detection arrangement comprises at least one anchor connection structure sensor configured to detect at least one anchor connection structure parameter of the anchor connection, and
the detection arrangement comprises at least one anchor connection structure evaluation module configured to detect the anchor connection break indication based on the at least one detected anchor connection structure parameter and at least one predetermined allowable anchor connection structure parameter range.

12. Floatable offshore structure, comprising:
at least one submarine cable connector configured to connect a submarine power cable of the offshore structure to at least one electrical device of the offshore structure,
at least one messenger line,
wherein a first end of the messenger line is fixed to the submarine power cable and a further end of the messenger line is fixed to the offshore structure,
wherein the floatable offshore structure further comprises at least one anchor connector configured to connect at least one anchor connection for anchoring the floatable offshore structure to a subsea floor,
wherein the floatable offshore structure further comprises:
at least one detection arrangement configured to detect an anchor connection break indication, and
at least one switching device configured to at least electrically disconnect the electrical connection to the submarine power cable connected to the submarine cable connector upon or after a detection of the anchor connection break indication.

13. Messenger line arrangement, comprising:
at least one buoy, and
at least one messenger line, wherein a first end of the messenger line is fixable to a submarine power cable connected to a submarine cable connector of an offshore structure and a further end of the messenger line is fixed to the buoy, and
wherein the messenger line is configured to hold a broken submarine power cable.

14. Submarine power cable arrangement, comprising:
at least one submarine power cable, and
a messenger line arrangement according to claim 13, wherein a first end of the messenger line is fixed to the submarine power cable.

15. Power generation system, comprising:
at least one offshore structure, comprising:
at least one submarine cable connector configured to connect a submarine power cable of the offshore structure to at least one electrical device of the offshore structure, and
at least one messenger line,
the submarine power cable comprises a weak link in the end area of the first end of the submarine power cable, wherein a first end of the messenger line is fixed to the submarine power cable downstream the weak link starting from the submarine cable connector of the offshore structure, wherein the weak link is an area of the submarine power cable that is mechanically and/or structurally configured in such a way that the tensile strength at said weak link is lower than in the remaining cable area of the submarine power cable.
and
at least one submarine power cable arrangement comprising:
the submarine power cable, and
a messenger line arrangement comprising:
at least one buoy, and
the messenger line, wherein the submarine power cable is connected to the submarine cable connector of the offshore structure and a further end of the messenger line is fixed to the buoy, and
wherein the messenger line is configured to hold a broken submarine power cable.

16. Offshore structure according to claim 1, wherein
the offshore structure is a floatable offshore structure.

17. Offshore structure according to claim 2, wherein
wherein the length of the end area is between 0 m and 20 m.

18. Offshore structure according to claim 11, wherein
wherein the at least one anchor connection structure sensor is selected from the group, comprising:
at least one electrical sensor configured to detect at least one electrical parameter of an electrical conductor guided at least partially along the anchor connection,
at least one optical sensor configured to detect at least one optical parameter of an optical conductor guided at least partially along the anchor connection,
at least one mechanical sensor configured to detect at least one mechanical parameter of a measuring rope guided at least partially along the anchor connection.
